(19) United States
(12) Patent Application Publication
(10) Pub. No.: US 2019/0251126 A1
(43) Pub. Date: Aug. 15, 2019

(54) MULTI-AGENT BASED VIRTUAL ASSISTANT

(71) Applicant: CogniCor Technologies, Inc., Folsom, CA (US)

(72) Inventors: Sindhu Joseph, Folsom, CA (US); Rosh Cherian, Folsom, CA (US); Vishal Yadav, Jaipur (IN)

(73) Assignee: CogniCor Technologies, Inc., Folsom, CA (US)

(21) Appl. No.: 16/273,211

(22) Filed: Feb. 12, 2019

Related U.S. Application Data
(63) Continuation-in-part of application No. 15/041,486, filed on Feb. 11, 2016.
(60) Provisional application No. 62/625,108, filed on Feb. 1, 2018.
(60) Provisional application No. 62/115,574, filed on Feb. 12, 2015.

(51) Int. Cl. G06F 16/903; G06N 20/00; G06F 17/28

(52) U.S. Cl. CPC G06F 16/90335; G06F 17/28; G06N 20/00

(57) ABSTRACT

A service based automated assistant uses a response logic to connect a user to helpful responses. The response logic involves a bidding system that uses contract net initiators that generate and evaluate bids and contract net responders that transmit the bids and bid evaluations downstream in the logic to service agents for evaluation and bidding, and upstream back to the user.

### RELATED APPLICATIONS

This application is a continuation-in-part application of U.S. application Ser. No. 15/041,486 filed Feb. 11, 2016, which claims priority to U.S. Application No. 62/115,574 filed Feb. 12, 2015. This application also claims priority to U.S. Application No. 62/625,108 filed Feb. 1, 2018. The contents of all three applications are incorporated by reference in full as if fully set forth herein.

### BACKGROUND

Machine learning and artificial intelligence programming are an active research area while government and private industry seek ways to improve mechanical learning and problem-solving. Companies in many industries, including even the medical field, are exploring ways to create artificial brain that is capable of finding the most likely cause of, and solution to, problems presented by people and organizations.

The challenge presented to these machine assistants are multifold. First, the system has to parse the actual interaction with the people it interacts with. This involves not only interpreting a person's word choice and usage, but also having insight into the mistakes or facts that the person makes in its interaction with the machine assistant. Second, the machine assistant, to be most effective, should get insight into when a person is losing patience or reaching a frustration threshold, such that manual intervention may be necessary. Third, the machine assistant needs to effectively and efficiently parse the interaction to deliver the most helpful response. Fourth, the machine assistant needs to learn from previous interactions and answers to provide better feedback to future inquiries and interactions.

Existing Approaches to Building Virtual Assistants and why they Fall Short

The industry and vendors are still figuring out the best way to build or configure cognitive virtual assistants. That said, there are primarily two approaches that is in emergence for a while, the platform driven approach and the bespoke approach. With the likes of Amazon (Lex platform), Microsoft (Bot framework) and IBM Watson (Watson platform) taking the platform route, platform-based approaches for now are much more prevalent. And it is because of the inherent advantages of a platform-based approach, they are more cost effective, they can prioritize deployment over development, they have the evidence of proof, they are more scalable, and they are easily configurable.

However, the platforms mentioned above can only configure a virtual assistant that has a rather simplistic intention/skill driven world model. That is, there are a set of predefined intentions/skills and every interaction/query is mapped to one of these predefined set of intentions/skills and a predefined action (response, workflow) is triggered. Most often a machine learning/deep learning algorithm is used to learn to recognize the intentions/skills by use of sample use of the intention in different contexts (utterances). Over a time, these intentions/skills are learnt fairly well and we have Alexa's, Google home's and Watson's of the world.

A typical conversation with such systems may be the following:

User: “I am hungry”

Current Virtual assistant: “I can suggest the following nearby restaurants”

This conversation would be the same no matter whether it is conducted at 2 pm in the afternoon, or 5 am in the morning. It also would be the same irrespective of the user likes to go to restaurants or only eats home cooked meals. It would also be the same whether a child has asked the question or an adult. The reason is in all the above scenarios, the identified intention/skill is “find Restaurants that are nearby.” Now imagine the following set of conversations:

User: “I am hungry”

A new Virtual Assistant: “Oh . . . it's just 5 am in the morning. You don't seem to have had a good dinner. Would you like to go out? There is a great 24/7 breakfast place nearby that I can suggest.”

User: “I am hungry”

A new Virtual Assistant: “Shall I wake your mom and let her know that you would like to have an early breakfast.”

User: “I am hungry”

A new Virtual Assistant: “I have this new lunch recipe for you, It not only uses super healthy ingredients, but we can make it within just 10 minutes. I am sure you would love it. Shall I read out the ingredients?”

In all the above scenarios, the user query was the same, and the identified intention is may be “need food.” However, in addition to identifying the query intention, the virtual assistant also uses other facts available to it such as its 5 am in the morning, the user will only eat home food and so on. Hence, even though all the possible action sequences are available to it, through a deductive reasoning, new information is deduced such as child need food-->alert mom, 5 am-->mom sleeping. When the earlier intention and the new derived facts considered together, the final intention becomes to “to wake up mom and send a note”.

Why are current virtual assistants not able to generate the above responses? From the utterance of the user, a single intent is identified based on a logic centered around patterns and machine learning without this intent being connected to any real world concepts or features. The system has no awareness about the interconnections or interdependencies of the elements of that domain, but blindly learns patterns of association between a set of utterances and intentions. Such lack of context and inability to connect the role of the user within that context makes it a single dimensional, shallow system. Once the system identifies the intention, it then fulfils the intent based on some pre-configured logic. In addition, the performance goals of the system are often decided at design time. However, in a real enterprise scenario, the goals of the system often changes adapting to the changing needs of the enterprises.

The new virtual assistant depicted above must be composed of different components that are able to recognize and pickup many contextual cues from a conversation such as sentiment, user profile, contextual information such as time and place of the day, and the kind of statement made by the user. The core of such systems are built on an inference driven reasoning engine in addition to the capability to recognize intentions. From these considerations, it is evident that there is a need for decentralization and distributed governance to achieve a coherent response that matches with the demands of enterprise virtual assistants.

### SUMMARY OF THE EMBODIMENTS

The inventive multi-agent based virtual assistant addresses many, if not all, of these challenges and provides more advantages described below.

A computer system for improving service agent interaction between a user and one or more service agents includes a service agent module within a storage memory of a computer. The module receives an input query from a user; forwards the input query to a contract net initiator (CNI), wherein a CNI initiates a bid for a response to the input query; and forwards the bid to at least two contract net responder (CNR) agents in communication with the CNI, wherein the at least two CNRs forward the bid to CNIs that negotiate with one or more service agents that provide possible responses to the user query. When at least one service agent provides a response to the query, a CNI associated with the one or more service agents that provide a possible response to the query forwards the possible response to a CNR in communication therewith. The CNI that initiated the bid for a response to the input query evaluates the possible responses and forwards the responses to the user as a result of the evaluation.

### BRIEF DESCRIPTION OF THE DRAWINGS

FIG. 1A shows an embodiment of a network environment.

FIG. 1B shows block diagrams of a computing device.

FIG. 1C shows an overview of the basic elements of an interaction diagram embodying the invention.

FIG. 1D shows an overview of the multi-agent system (MAS) architecture.

FIG. 1E shows a communications flow in the MAS.

FIG. 1F shows the MAS and potential module interactions.

FIG. 2 shows an overview of a workflow of the logic of the system.

FIG. 3 shows an example screenshot of the system interacting with a user.

FIGS. 4-6 show a sequence of steps through a logic flow of providing a response to a user query.

FIG. 7 shows a sequence of further steps through the logic flow.

FIG. 8 shows an example business workflow.

### DETAILED DESCRIPTION OF THE EMBODIMENTS

### Introduction

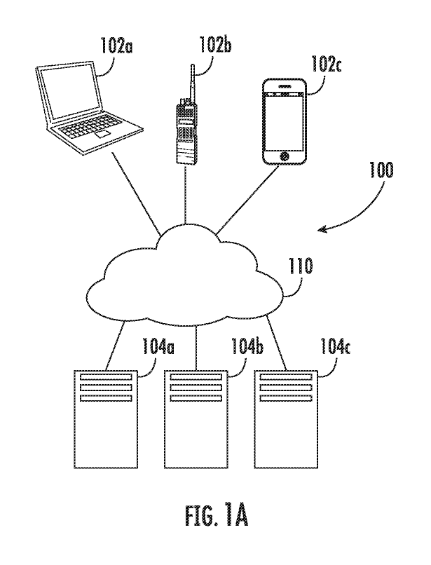

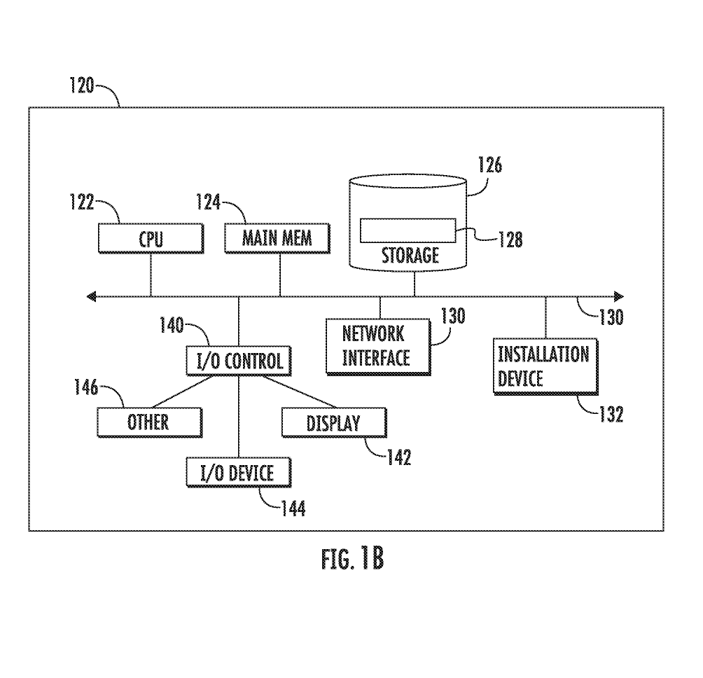

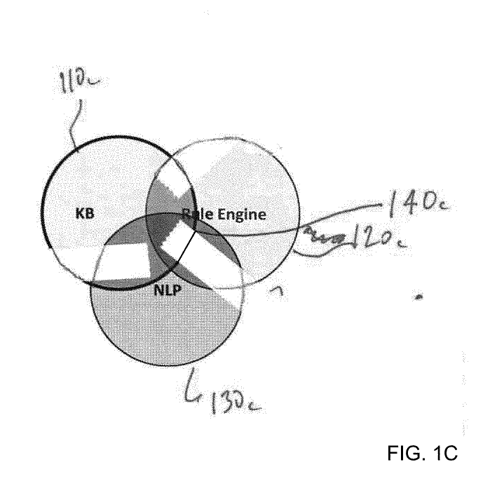

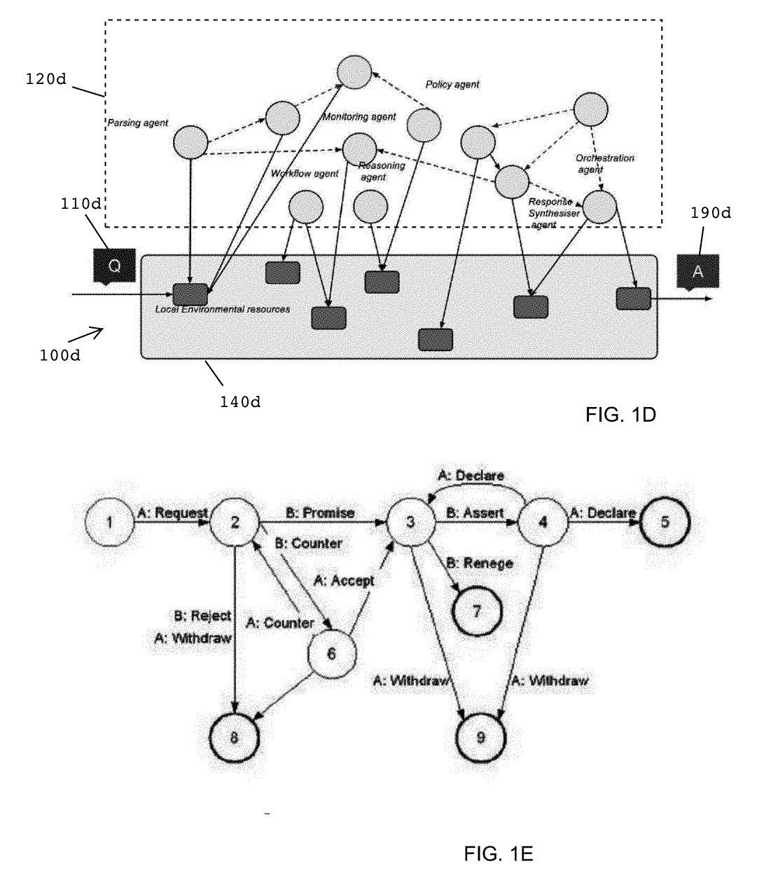

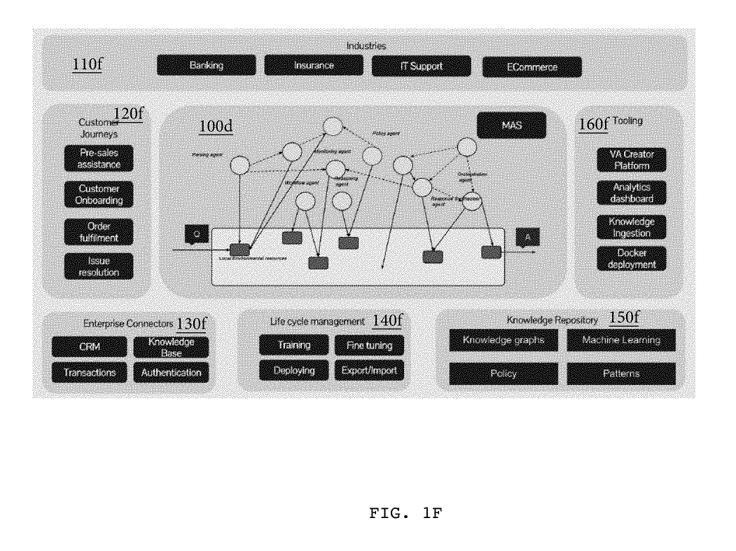

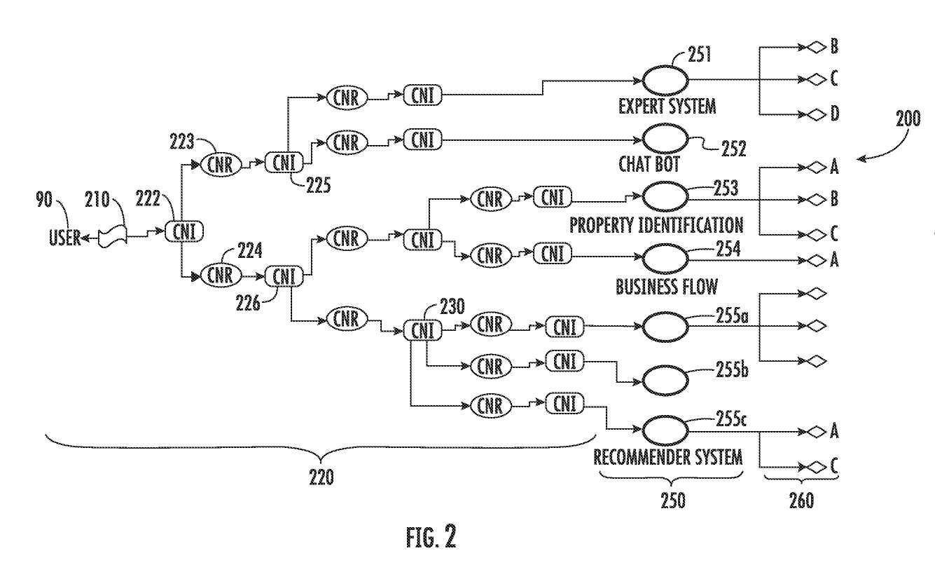

The system and method of improving machine learning including in a service agent as described herein may be implemented using system and hardware elements. For example, FIG. 1A shows an embodiment of a network 100 with one or more clients 102a, 102b, 102c that may be local machines, personal computers, nodes, mobile devices, servers, tablets that communicate through one or more networks 110 with servers 104a, 104b, 104c, which may be hosts to networks themselves. It should be appreciated that a client 102a-102c may serve as a client seeking access to resources provided by a server and/or as a server providing access to other clients.

The network 110 may be wired or wireless links. IF it is wired, the network may include coaxial cable, twisted pair lines, USB cabling, or optical lines. The wireless network may operate using BLUETOOTH, Wi-Fi, Worldwide Interoperability for Microwave Access (WiMAX), infrared, or satellite networks. The wireless links may also include any cellular network standards used to communicate among mobile devices including the many standards prepared by the International Telecommunication Union such as 3G, 4G, and LTE. Cellular network standards may include GSM, GPRS, LTE, WiMAX, and WiMAX-Advanced. Cellular network standards may use various channel communications such as FDMA, TDMA, CDMA, or SDMA. The various networks may be used individually or in an interconnected way and are thus depicted as shown in FIG. 1A as a cloud.

The network 110 may be located across many geographies and may have a topology organized as point-to-point, bus, star, ring, mesh, or tree. The network 110 may be an overlay network which is virtual and sits on top of one or more layers of other networks.

The network 110 may use certain protocols including the Ethernet protocol, the internet protocol suite (TCP/IP), the ATM (Asynchronous Transfer Mode) technique, the SONET (Synchronous Optical Networking) protocol, or the SDH (Synchronous Digital Hierarchy) protocol. The TCP/IP internet protocol suite may include application layer, transport layer, internet layer, or the link layer. The network 110 may be a type of a broadcast network, a telecommunications network, a data communication network, or a computer network.

In most cases, every device on a network has a unique identifier. In the TCP/IP protocol, the unique identifier for a computer is an IP address. An IPv4 address uses 32 binary bits to create a single unique address on the network. An IPv4 address is expressed by four numbers separated by dots. Each number is the decimal (base-10) representation for an eight-digit binary (base-2) number, also called an octet. An IPv6 address uses 128 binary bits to create a single unique address on the network. An IPv6 address is expressed by eight groups of hexadecimal (base-16) numbers separated by colons.

An IP address can be either dynamic or static. A static address is one that a user can edit and it is less common. Dynamic addresses are assigned by the Dynamic Host Configuration Protocol (DHCP), a service running on the network. DHCP typically runs on network hardware such as routers or dedicated DHCP servers.

Dynamic IP addresses are issued using a leasing system, meaning that the IP address is only active for a limited time. If the lease expires, the computer will automatically request a new lease. Sometimes, this means the computer will get a new IP address, too, especially if the computer was unplugged from the network between leases. This process is usually transparent to the user unless the computer warns about an IP address conflict on the network (two computers with the same IP address).

Information in the IP Address may be used to identify users, devices, geographies, and networks.

A system may include multiple servers 104a-c stored in high-density rack systems. If the servers are part of a common network, they do not need to be physically near one another but instead may be connected by a wide-area network (WAN) connection or similar connection.

Management of group of networked servers may be de-centralized. For example, one or more servers 1041-c may include modules to support one or more management services for networked servers including management of dynamic data, such as techniques for handling failover, data replication, and increasing the networked server's performance.

The servers 104a-c may be file servers, application servers, web servers, proxy servers, network appliances, gateways, gateway servers, virtualization servers, deployment servers, SSL VPN servers, or firewalls.

When the network 110 is in a cloud environment, the cloud network 110 may be public, private, or hybrid. Public clouds may include public servers maintained by third parties. Public clouds may be connected to servers over a public network. Private clouds may include private servers that are physically maintained by clients. Private clouds may be connected to servers over a private network. Hybrid clouds may, as the name indicates, include both public and private networks.

The cloud network may include delivery using IaaS (Infrastructure-as-a-Service), PaaS (Platform-as-a-Service), SaaS (Software-as-a-Service) or Storage, Database, Information, Process, Application, Integration, Security, Management, Testing-as-a-service. IaaS may provide access to features, computers (virtual or on dedicated hardware), and data storage space. PaaS may include storage, networking, servers or virtualization, as well as additional resources such as, e.g., the operating system, middleware, or runtime resources. SaaS may be run and managed by the service provider and SaaS usually refers to end-user applications. A common example of a SaaS application is SALESFORCE or web-based email.

A client 102a-c may access IaaS, PaaS, or SaaS resources using preset standards and the clients 102a-c may be authenticated. For example, a server or authentication server may authenticate a user via security certificates, HTTPS, or API keys. API keys may include various encryption standards such as, e.g., Advanced Encryption Standard (AES). Data resources may be sent over Transport Layer Security (TLS) or Secure Sockets Layer (SSL).

The clients 102a-c and servers 104a-c may be embodied in a computer, network device or appliance capable of communicating with a network and performing the actions herein. FIGS. 1B and 1C show block diagrams of a computing device 120 that may embody the client or server discussed herein. The device 120 may include a system bus 150 that connects the major components of a computer system, combining the functions of a data bus to carry information, an address bus to determine where it should be sent, and a control bus to determine its operation. The device includes a central processing unit 122, a main memory 124, and storage device 124. The device 120 may further include a network interface 130, an installation device 132 and an I/O control 140 connected to one or more display devices 142, I/O devices 144, or other devices 146 like mice and keyboards.

The storage device 126 may include an operating system, software, and a service agent module 128, in which may reside the service agent logic and method described in more detail below.

The computing device 120 may include a memory port, a bridge, one or more input/output devices, and a cache memory in communication with the central processing unit.

The central processing unit 122 may be a logic circuitry such as a microprocessor that responds to and processes instructions fetched from the main memory 124. The CPU 122 may use instruction level parallelism, thread level parallelism, different levels of cache, and multi-core processors. A multi-core processor may include two or more processing units on a single computing component.

The main memory 124 may include one or more memory chips capable of storing data and allowing any storage location to be directly accessed by the CPU 122. The main memory unit 124 may be volatile and faster than storage memory 126. Main memory units 124 may be dynamic random-access memory (DRAM) or any variants, including static random-access memory (SRAM). The main memory 124 or the storage 126 may be non-volatile.

The CPU 122 may communicate directly with a cache memory via a secondary bus, sometimes referred to as a backside bus. In other embodiments, the CPU 122 may communicate with cache memory using the system bus 150. Cache memory typically has a faster response time than main memory 124 and is typically provided by SRAM or similar RAM memory.

Input devices may include keyboards, mice, trackpads, trackballs, touchpads, touch mice, multi-touch touchpads and touch mice, microphones, multi-array microphones, drawing tablets, cameras, single-lens reflex camera (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors. Output devices may include video displays, graphical displays, speakers, headphones, inkjet printers, laser printers, and 3D printers.

Additional I/O devices may have both input and output capabilities, including haptic feedback devices, touchscreen displays, or multi-touch displays. Touchscreen, multi-touch displays, touchpads, touch mice, or other touch sensing devices may use different technologies to sense touch, including, e.g., capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, e.g., pinch, spread, rotate, scroll, or other gestures.

In some embodiments, display devices 142 may be connected to the I/O controller 140. Display devices may include liquid crystal displays (LCD), thin film transistor LCD (TFT-LCD), blue phase LCD, electronic papers (e-ink) displays, flexile displays, light emitting diode displays (LED), digital light processing (DLP) displays, liquid crystal on silicon (LCOS) displays, organic light-emitting diode (OLED) displays, active-matrix organic light-emitting diode (AMOLED) displays, liquid crystal laser displays, time-multiplexed optical shutter (TMOS) displays, or 3D displays.

The computing device 120 may include a network interface 130 to interface to the network 110 through a variety of connections including standard telephone lines LAN or WAN links (802.11, T1, T3, Gigabit Ethernet), broadband connections (ISDN, Frame Relay, ATM, Gigabit Ethernet, Ethernet-over-SONET, ADSL, VDSL, BPON, GPON, fiber optical including FiOS), wireless connections, or some combination of any or all of the above. Connections can be established using a variety of communication protocols. The computing device 120 may communicate with other computing devices via any type and/or form of gateway or tunneling protocol such as Secure Socket Layer (SSL) or Transport Layer Security (TLS). The network interface 130 may include a built-in network adapter, network interface card, PCMCIA network card, EXPRESSCARD network card, card bus network adapter, wireless network adapter, USB network adapter, modem or any other device suitable for interfacing the computing device 120 to any type of network capable of communication and performing the operations described herein.

The computing device 120 may operate under the control of an operating system that controls scheduling of tasks and access to system resources. The computing device 120 may be running any operating system such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein.

The computer system 120 can be any workstation, telephone, desktop computer, laptop or notebook computer, netbook, tablet, server, handheld computer, mobile telephone, smartphone or other portable telecommunications device, media playing device, a gaming system, mobile computing device, or any other type and/or form of computing, telecommunications or media device that is capable of communication.

The status of one or more machines 102a-c, 104a-c may be monitored, generally, as part of network management. In one of these embodiments, the status of a machine may include an identification of load information (the number of processes on the machine, CPU and memory utilization), of port information (the number of available communication ports and the port addresses), session status (the duration and type of processes, and whether a process is active or idle), or as mentioned below. In another of these embodiments, this information may be identified by a plurality of metrics, and the plurality of metrics can be applied at least in part towards decisions in load distribution, network traffic management, and network failure recovery as well as any aspects of operations of the present solution described herein. Aspects of the operating environments and components described above will become apparent in the context of the systems and methods disclosed herein.

MAS-Based Virtual Assistants Introduction

What follows in this section is an introduction, further supplemented hereafter in detail. The multi-agent systems seek to understand how independent processes can be coordinated. An agent may be a computerized entity like a computer program or a robot. An agent can be described as autonomous because it has the capacity to adapt when its environment changes. A multi-agent system is made up of a set of such processes that occur at the same time, i.e. several agents that exist at the same time, share common resources and communicate with each other.

Multi-agent systems can be applied to artificial intelligence and in particular to configuring virtual assistants. They simplify achieving objectives or problem-solving by dividing the necessary knowledge into subunits—to which an independent intelligent agent is associated, and by coordinating the agents' activity. The agents may include the following characteristics.

1—Such a multi-agent system based approach may allow a goal or problem or issue received as input to be partitioned into a number of smaller, simpler components which may be developed, maintained, managed, and supplemented. This multi-agent system provides a way of addressing an objective by mapping the objective into further autonomous agents that have their own resources and expertise and can interact with others to get tasks done. An agent functions for the goals to which it has some relative knowledge or programming to address the goal. Each agent may provide knowledge, evaluate knowledge, or work through intermediary agents to achieve its goal.

2—The multi-agent system may also allow setting higher level system wide goals. For example, consider a mandatory response that is expected from such a system within 0.01 microseconds. Such a system wide objective can be set within a multi-agent system and each agent would adapt its behavior to optimize this objective.

3—Higher business level goals can also be set such as 10 insurance policies need to be sold per day or no customer should leave angry from a conversation in which case the sentiment agent responses take precedence over other agent responses.

4—Both these business goals as well as system level goals can be changed at any time and the multi-agent system may respond to the change of goals automatically. Likewise, certain rules of governance can also be set in such a system and each agent will obey these rules.

5—And finally, into such a system, any number of specialized agents can be introduced without making any additional systemic changes as those are already defined.

MAS-Based Architecture Introduction

An instantiation of a MAS based architecture to cognitive virtual assistant is as shown in FIG. 1D, with the details discussed following this introduction. Within FIG. 1, a user query 110d is received by the system architecture 100d, which generates a response 190d using various agents 120d that draw on resources 140d.

There may be three types of agents: CNI (Contract Net Initiators Agent)—When a user input is received, this agent generates bid for response among all CNR agents connected to it, CNR (Contract Net Responder Agent)—This Agent negotiates with service agents and if they are able to provide response for a user input, CNR agents try to take part in bid generated by CNI by providing response to CNI. Finally Service Agents are the ones that perform the actual tasks, such as the various kind of system services like intent identification, answer generation, business flow etc.

The communication and coordination among the agents may be carried out in the communications flow of FIG. 1E in which various agents labeled 1-9, and whose actions may include requesting bids, rejecting and withdrawing bids, accepting bids, countering bids, promising, declaring, and reneging. Any of these actions may be possible by the agents in seeking a response to the user input.

Each user input presents a bidding opportunity for response by the architecture 100d, where the bidding opportunity may be split into sub bids. Each of the CNI agents that may respond to a user input has a logic built in, based on a subdomain expertise logic, where such logic may be programmatically adaptable, to evaluate bids from the CNR agents and select a winner. The adaptability of the CNI agents allows them to distinguish between bid responses that have been more successful over time, through trial and error or pre-programmed logic preference, and select those preferred bids. Such a multi-agent system allows for parallel problem solving (bidding), which is critical both in speed of response, but also in ensuring that the system doesn't crash due to some faulty logic. It is also inherently scalable for more complicated or multi-layered queries.

Each service agent may further initiate a bid to certain universal service agents, which may be responsive and connected to all of the ordinary service agents through a CNI agent. An example of a universal service agent may be lateral language NLP preprocessing, which would always have the option of bidding on a response in order to process a user input properly.

The service agents may be of many types, some of which follow and include: working memory, in domain response generation, out domain response generation, user intent identification, instance identification, business flow, NLP processing, sentiment analysis, and conversation planning. Some of these service agents are described as below.
In-Domain Response Generation Service: This agent may contain specific domain knowledge. It may use identified instances and user intent information provided by other services to prepare a proper response drawing from a stored knowledge set.
User Intent Identification Service: This service may include 2 agents. A first agent may derive user intent from a query and store the user intent in working memory. A second agent may try to break down complex user intent by asking probing questions in the hope of breaking down the user intent.
Sentiment Analysis Service: This service may include two agents. A first agent may analyze and store an analysis of user sentiment that is stored against a user profile in the working memory. User sentiment may be a universal service that could be used by other services or agents. For example, if the user sentiment is identified as “angry” or “upset,” the system may bypass other responses in bids and more readily recommend human intervention. A second agent may determine a bot sentiment, which is also a universal service. Bot sentiment may include the tone of replies being delivered to the user.
Conversation Planning Service: This agent sets the goal of the conversation bot by following a conversation policy. The intermediate goal of the conversation policy relates to reacting to universal services (like user sentiment) that can be used by other services.

Learning in MAS

Learning in MAS can be for individual agents or for the entire system. Single agent training includes for example, training the sentiment agent. A sentiment agent can be trained to recognize sentiment from previous conversations. Another important single agent training is for the Knowledge Ingestion agent. The responsibility of Knowledge Ingestion agent is to ingest different enterprise knowledge into the knowledge base of the virtual assistant from different document artifacts such as pdfs, word documents or websites. This agent can be trained to recognize document elements such as paragraphs, tables etc within pdf documents using a deep learning based algorithm.

Learning entire system behavior is another type of learning in MAS. There are two types of training that takes place within MAS, unsupervised and supervised. In the unsupervised learning, user feedback is used as a reinforcement to existing classification (normally intentions). If the suggested solution is selected or given a high rating, then the confidence on the response is given a delta increase in weight. A delta decrease in weight is made if the feedback is negative.

In the supervised learning, the previous conversations are manually annotated and an SVM (support vector machines) classifier is used to train the system with the augmented training set. The learning pipeline includes methods such as Word2Vec model used on domain specific repository of documents to improve the accuracy.

A system may include MAS 100d at its core and other functional modules needed for a production-ready multi-agent system around and in communication with the core as shown in FIG. 1F. The modules may include industries for use 110f, customer journeys or experiences 120f, enterprise connectors 130f, life cycle management 140f, knowledge repositories 150f, and tooling 160f.

Agents and Architecture in Learning Detailed Description

As shown in FIG. 1C, the assistant may include a knowledge base 110c, rule engine 120c, and natural language processor (NLP) 130c. The knowledge base 110c includes information and data such as the underlying facts and assumptions that may be helpful for the assistant to have access to. The knowledge base 110c may be preset with information and it may be expanded by crawling data sources, virtual assistant-user interactions, and other sources. The rule engine 120c includes rules and logic that organize responses and interaction with a user. Like the knowledge base 110c, the rules engine 120c may be self-adaptive by receiving new logic from other sources including assistant-user interaction. The natural language processor 130c may draw on natural language foundations of syntax, discourse, semantics, and where appropriate speech to interpret a user's meaning and emotional state. There are many natural language APIs that the natural language processor 130c may draw on one or combine many to perform its task.

Any two of these components may interact with one another. For example, the rules engine 120c may draw on the knowledge base 110c to search and retrieve information for its own tasks. Similarly, the knowledge base 110c may provide schemes and attributes to the natural language processor 130c. At the intersection of the knowledge base 110c, rule engine 120c, and natural language processor 130c, the virtual assistant delivers its response 140c to the user, and the virtual assistant draws on all of these components.

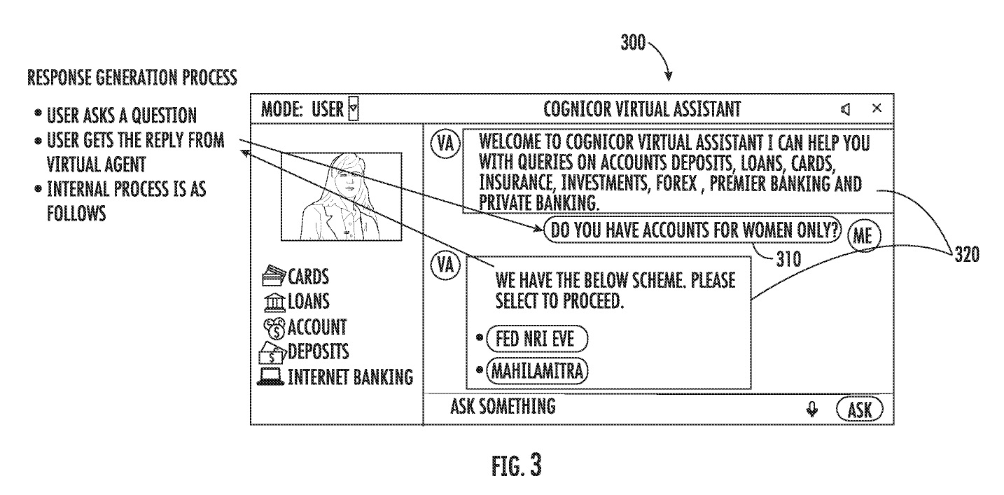

The knowledge base 110c, rule engine 120c, and NLP 130c may interact with each other and a user through an architecture shown in FIGS. 2-7. As shown in FIG. 2, the architecture 200 (which does not include the user 90), includes a user input query 210, contract agents 220, service agents 250, and responses 270 that are stored in the knowledge base 110c. Generally, the architecture 200 takes place within the rule engine 120c, although there is NLP overlap in user interaction and also knowledge base interaction.

Such a multi-agent system-based approach allows a problem or issue received as input to be partitioned into a number of smaller, simpler components which are easier to develop, maintain, manage and supplement. This multi-agent provides a way of addressing an issue by mapping its solution into autonomous problem-solving agents that have their own resources and expertise and can interact with others to get the tasks done.

An agent functions for the goals to which it has some relative knowledge or programming to address the goal. Each agent, as described below may provide knowledge, evaluate knowledge, or work through intermediary agents to achieve its goal.

Each agent's task goals give it a certain jurisdiction over its subagents (those that fall below it in hierarchy). A higher-level agent may use a lower level agent over which it has jurisdiction, as part of its defined goal.

Each agent may have a structure that includes information sharing, information receiving, actions, and available resources. The information sharing capability represents an area to which the agent posts information about its resources. Any agent that has usage rights over resources, or portions of resources, in this agent has read privileges for this area, if it can gain access to it.

Information receiving capability represents the ability of an agent to accept setup goals. The action capability represents the ability of an agent to accept an acting goal and to decompose it into other goals which it passes on to other agents, or into resources to which it has usage rights.

Finally, the resource capability represents the data and knowledge sources needed in the decomposition of a goal. It is private to an agent. For example, in support of this knowledge, a goal directory may break goal into their constituent parts, is written to and from the receiving capability, and used by the actions capability. The resources including basic function, capacity, constraints, bidding mechanism, may also be contained in this capability, as well as the knowledge source needed to utilize a resource.

In use where the architecture 200 is supporting a virtual assistant, a user 90 may initiate an interaction with the virtual assistant by creating an input 210. The input 210 may include a voice message, text message, screen shot, video chat, or other input where the user may convey their concern to a virtual assistant. The NLP 130c applies its language processing logic to the user input 210 to generate and create concepts for the architecture 200 to analyze respond to.

The architecture 200 receives the post-NLP user input 210 at a Contract Net Initiator (CNI) agent 222. The term “agent” relates to software and associated hardware on which it is implemented, wherein the agent carries out a task according to an adaptable logic. The CNI agent 222 generally generates a bid for response among Contract Net Responder (CNR) agents connected to it, in this specific instance of the level one CNI agent 222, it is connected to level one CNR agents 223, 224. The CNR agents forward bids through the logic to CNI agents, which negotiate and interact with service agents 250 to secure possible responses to the user input 210, and thus attempt to provide a response to a user input 210 by participating in the “bid” generated by the CNI agent that created the bid. CNR agents thus act as messengers without selection logic, and may be reused in the network for other message forwarding.

In the case shown in FIG. 2, when the CNI agent 222 generates a bid, CNR agents 223, 224 will attempt to provide a response from among the responses they receive from further downstream CNI agents 225, 226. Through a series of CNI and CNR agents, where eventually a CNI agent will reach one of the service agents 250, shown non-exhaustively in FIG. 2 as an expert system 251, chat bot 252, property identification 253, business flow 254, and recommender system 255. Any one of, or multiple of, these service agents may provide bids to CNI agents, which may in the end provide a preferred response to the user.

Explained another way, when at least one service agent 250 provides a response to the query, a CNI 225, 226 associated with the one or more service agents that provide a possible response to the query forwards the possible response through the logic to the CNI 222, wherein the CNI 222 evaluates the possible responses and forwards the responses to the user 210 as a result of the evaluation. As can be seen, the CNIs, CNRs, and service agents form a network logic wherein CNIS are in communication with either CNRs or service agents and CNRs are only in communication with CNIs.

Within the architecture 200, each user input presents a bidding opportunity for response by the architecture, where the bidding opportunity may be split into subbids. Each of the CNI agents that may respond to a user input has a logic built in, based on a subdomain expertise logic, where such logic may be programmatically adaptable, to evaluate bids from the CNR agents and select one or more “winners.” The adaptability of the CNI agents allows them to distinguish between bid responses that have been more successful over time, through trial and error or pre-programmed logic preference, and select those preferred bids. Such a multi-agent system allows for parallel problem solving (bidding), which is critical both in speed of response, but also in ensuring that the system doesn't crash due to some faulty logic. It is also inherently scalable for more complicated or multi-layered queries.

It should be appreciated for example in the logic shown in FIG. 2, that the recommender system includes three recommender system service agents 255a, 255b, 255c. Each of these may have a different expertise, such as in the example that follows, one recommender service agent 255a may have an expertise in low interest rate accounts, another recommender service agent 255b, may have an expertise in credit card recommendations, and yet another recommender service agent 255c may have an expertise in specialty accounts for women.

Looking at the logic of CNIs and CNRs, it can be appreciated that the specific CNI agent 230 have been programmed to generate a bid that will be forwarded to each of the three recommender system service agents 255a, 255b, 255c that are “grouped” together, while the CNI agent 225 has generated a bid that will be forwarded to the expert system 251 and chat bot 252 that are similarly grouped together. Service agents may be grouped together according to like properties (recommendation system service agents make recommendations, and thus recommendations are the like property). Service agents may also be grouped together if they have competing or unlike properties, for example a chat bot service agent 252 may be grouped to bid against an expert system 251 so that unlike service agents may make bids that contrast to one another.

Returning to the architecture 200, each service agent 250 may further initiate a bid to certain universal service agents 260, which may be responsive and connected to all of the ordinary service agents through a CNI agent. An example of a universal service agent may be NLP preprocessing, discussed later herein, which would always have the option of bidding on a response in order to process a user input properly.

Turning to an example of how the architecture 200 might work, A user may enter a dialogue 300 with a virtual agent, where as shown in the dialogue 300, the user's dialogue 310 and virtual assistant dialogue 320 occupy separate sides of the dialogue 300.

In the dialogue 300, the virtual assistant first greets the user and prompts them for an inquiry. The user responds in the user dialogue 310, as shown in the example, with a request “Do you have accounts for women only?” The virtual assistant, using the method and system described herein, responds with two options to pursue.

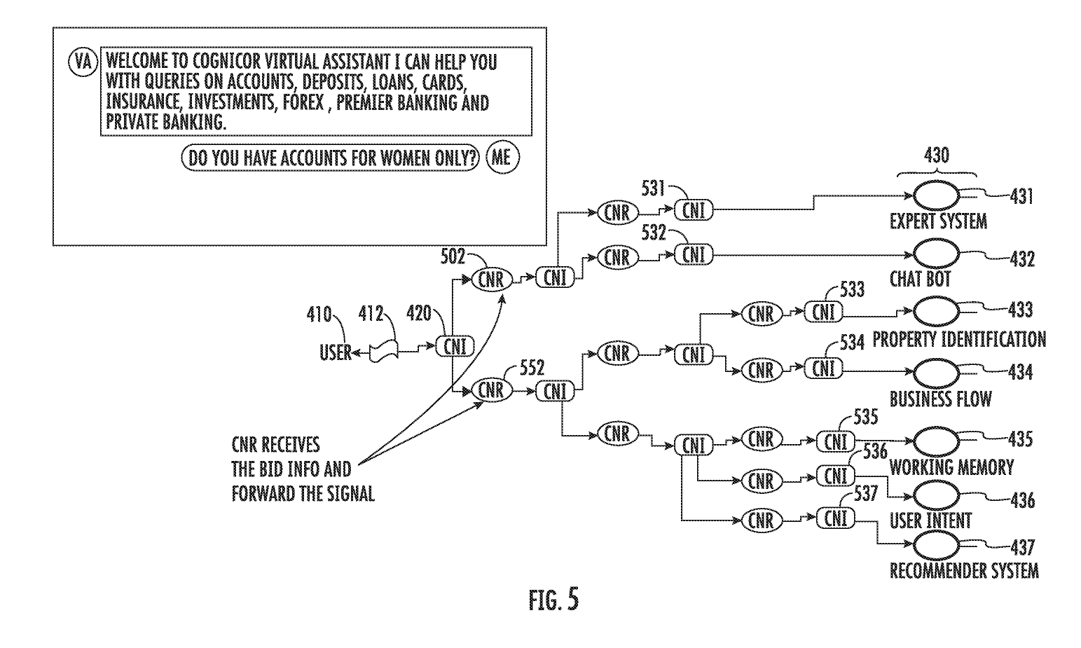

FIG. 4 shows an overall decision architecture from a user 410, their request 412, and the flow to service agents 430, which the figures and description that follows captures this in more detail. Initially, the user request 412, in this example, “Do you have accounts for women only,” is sent to a first CNI agent 420, which initiates a bid.

As shown in FIG. 5, the first CNI agent 420, having initiated a bid, forwards the signal to two or more CNR agents 502, 552. The process of CNIs initiating bids and CNRs forwarding signals is carried on through final CNIs 531, 532, 533, 534, 535, 536, 537 that forward signals downstream (away from the user) to the service agents 430,

The service agents 430 may offer several services, some of which are discussed below, and as shown, may include an expert system 431, chat bot 432, property identification 433, business flow 434, working memory 435, user intent 436, and recommender system 437. In the example being discussed, each service agent 430, upon receiving the signal, chooses to respond, or not respond, to a bid based on the content of the bid. Other service agents are possible and may span other areas of expertise. Thus, for the user request 412, as shown in FIG. 6, the recommender service 637 provides a bid with a reply message while the other services 631, 632, 633, 634, 635, and 636 refuse the bid. It should be understood that more than one service, however, may bid, and in such a case, the CNI receiving two (or more) bids may choose the bid of higher value and pass it along to an upstream (towards the user) CNI or choose to pass on all bids.

As each service agent submits its bid for a response, its immediate upstream CNI chooses to take the response from the service agent. The CNI agent may have at least one selection logic that may be subject to the network logic structure and the functions of downstream service agents, or the logic will be a priority based selection between the bids.

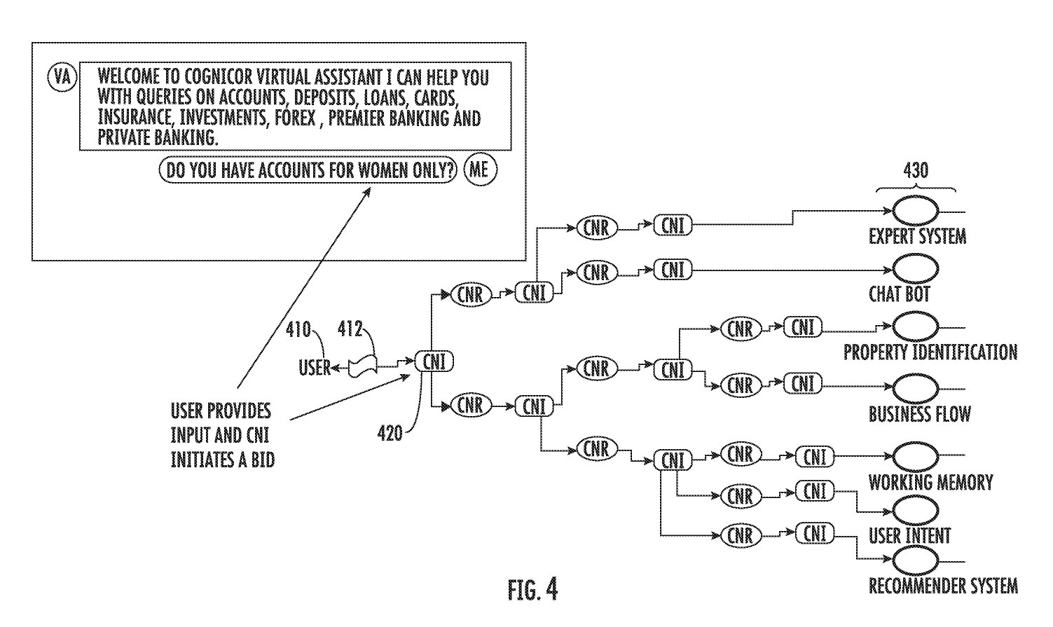

In this example, the CNI 537 may agree to take the response from the recommender system 637. Each CNI that receives two or more responses (including non-responses) evaluates the bid placed by the service agent and passes the bid on to an upstream CNR, with the process continuing until the initial CNI 420 evaluates the top bids received from its initial bid. Just as the other CNIs evaluate the bid, the initial CNI evaluates all received bids and selects the response, which in this example from the recommender system, referring back to FIG. 3, is “We have the information below. . . . ”

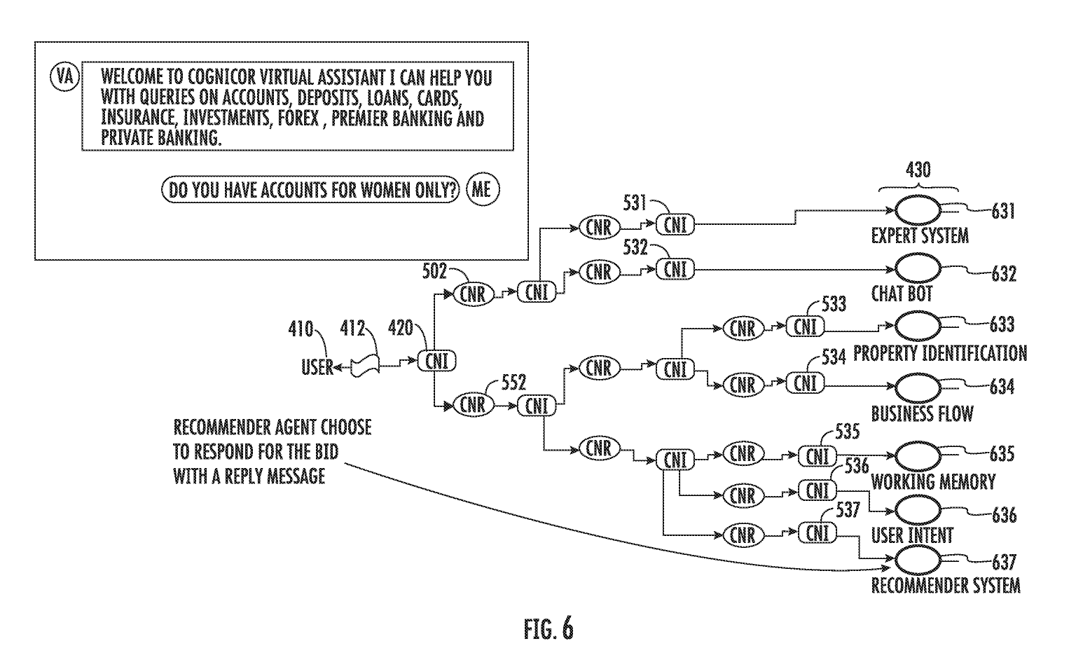

As shown in FIG. 7, as the user dialogue 700 proceeds, a user 410 may select one of the presented options or otherwise respond 702. This response 702 initiates a new user request 712, which proceeds through the CNI/CNR logic as before but with two service agents 430 providing a big and response, namely the chat bot 732 “This is also my favorite” and expert system service agent 731 “We understand. . . . ” The first CNI to receive both of these bids 722 may select both responses and pass them on upstream to the immediately upstream CNR 750. The bid-initiating CNI 720 may evaluate those responses and others and deliver those responses to the user as shown in the dialogue 700 in lines 704 (chat bot service agent response) and lines 706, 708 (expert system service agent response).

The service agents 250 may be of many types, some of which follow and include: working memory, in domain response generation, out domain response generation, user intent identification, instance identification, business flow, NLP processing, sentiment analysis, and conversation planning.

Working Memory Service. The working memory service may include 3 subagents embodied in machine readable memory, where agent one remembers the current instance of the user interaction with the architecture, agent two remembers current user intent or instance attributes, such as cost, features, benefits, account balances, and many others; and agent three fills a user profile and remembers it for later retrieval for use in other services. Given its relationship to storing and retrieving user instances, as well as filling out a user profile, the working memory service would almost always be activated for every user interaction. The exception could be if the user does not respond to initial “Hello” or “What is your concern today” prompts from the architecture.

In-Domain Response Generation Service. This agent may contain specific domain knowledge. It may use identified instances and user intent information provided by other services to prepare a proper response drawing from a stored knowledge set.

Out-Domain Response Generation Service. This agent responds to user questions outside the knowledge domain covered by the in-domain service. Example responses are usually intentionally vague and intended to close a conversation, such as how to respond to a user query such as “What color are your eyes?” In response to such a non-task-oriented query, the Out-Domain Response Generation Service may respond with, “This does not seem relevant to our discussion. Are you finished with your questions for this session?”

User Intent Identification Service. This service may include 2 agents. A first agent may derive user intent from a query and store the user intent in working memory. A second agent try to break down complex user intent by asking probing questions in the hopes of breaking down the user intent. The goal of the user intent identification service is to understand what features a user needs.

Instance Identification Service. This service may include 2 agents. A first agent recommends Instances to a user based on their profiles and other product profile constraints by asking questions. For example, the agent my probe a user for who has a question about an account, but who owns multiple accounts, to specify which account they have a query about. A second agent may pick an Instance from a user query and store to working memory during a session with a user. The goal of the Instance Identification Service is to track earlier user instances of inquiries or other interactions with the system to streamline user interaction. Upstream CNIs from the Instance Identification Service may be hard-coded, to for example, give priority to a bid initiated by the Instance Identification Service over another service like the Recommender System Service. In an example, perhaps the Recommender System Service places a bid to recommend certain accounts but the Instance Identification Service based on earlier knowledge places a bid to highlight just one account. In such a case, a CNI receiving both bids may not forward the bid from the Recommender System.

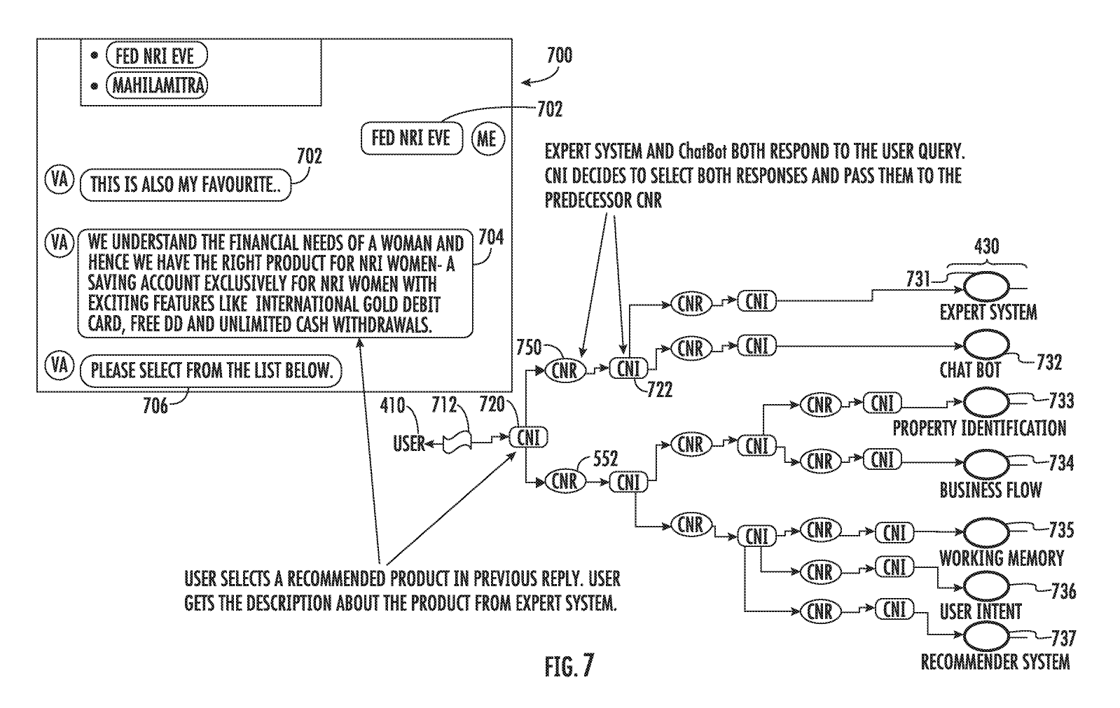

Business Workflow Service. This service may include at least one agent that executes one or more business workflows (see FIG. 8). Business workflows are processes that follow a logical progression to achieve a business end, such as signing up for an account, terminating an account, reacting to a call from an office, transferring funds, changing account types, etc.

NLP Preprocessing Service. This service may include an agent that performs basic NLP operations based on user input, where the operations include tokenization, lemmatization, spell correction, part of speech (POS) tagging, etc.

Sentiment Analysis Service. This service may include two agents. A first agent may analyze and store an analysis of user sentiment that is stored in a user profile in working memory. User sentiment may be a universal service that could be used by other services or agents. For example, if the user sentiment is identified as “angry” or “upset,” the system may bypass other responses in bids and more readily recommend human intervention according to a conversation policy. User sentiment may be divided into several class, such as positive, negative, and neutral, or on a spectrum, based on words being used by the user, account questions with historic bad sentiment and similar factors. A second agent may determine a bot sentiment, which is also a universal service. Bot sentiment may include the tone of replies being delivered to the user. Because this is a universal agent 160, other service agents may draw in the Sentiment Analysis Service at any time.

Conversation Planning Service. This agent sets the goal of the conversation bot by following a conversation policy. The intermediate goal of the conversation policy relates to reacting to universal services (like user sentiment) that can be used by other services.

While the invention has been described with reference to the embodiments above, a person of ordinary skill in the art would understand that various changes or modifications may be made thereto without departing from the scope of the claims.

1. A computer system for improving service agent interaction between a user and one or more service agents comprising:
a service agent module within a storage memory of a computer, the module configured to:
receive an input query from a user;
forward the input query to a contract net initiator (CNI), wherein a CNI initiates a bid for a response to the input query; and
forward the bid to at least two contract net responder (CNR) agents in communication with the CNI, wherein the at least two CNRs forward the bid to CNIs that negotiate with one or more service agents that provide possible responses to the user query;
wherein when at least one service agent provides a response to the query, a CNI associated with the one or more service agents that provide a possible response to the query forwards the possible response to a CNR in communication therewith, wherein the CNI that initiated the bid for a response to the input query evaluates the possible responses and forwards the responses to the user as a result of the evaluation.

2. The computer system for improving service agent interaction between a user and one or more service agents of claim 1, wherein the CNIs and CNRs form a network logic wherein CNIS are in communication with either CNRs or service agents and CNRs are only in communication with CNIs.

3. The computer system for improving service agent interaction between a user and one or more service agents of claim 1, wherein each of the at least one service agents provides a different expertise that may be responsive to the user input query.

4. The computer system for improving service agent interaction between a user and one or more service agents of claim 1, further comprising universal service agents that are responsive to all of the at least one service agents through a CNI agent and provide information to all of the at least one service agents, which information may assist in the service agents preparing a possible response.

5. The computer system for improving service agent interaction between a user and one or more service agents of claim 1, wherein the at least one service agent includes a working memory service comprising subagents embodied in machine readable memory, wherein agent one remembers the current instance of the user interaction with the system, agent two remembers current user intent, and agent three fills a user profile and remembers the user profile for later retrieval.

6. The computer system for improving service agent interaction between a user and one or more service agents of claim 1, wherein the at least one service agent includes a user intent identification service comprising a first agent that derives user intent and a second agent that derives user intent by asking probing questions of a user.

7. The computer system for improving service agent interaction between a user and one or more service agents of claim 1, wherein the at least one service agent includes an instance identification service comprising a first agent that recommends features to a user based on a user profile and a second agent that selects an instance from a user query and stores the instance to working memory.

8. The computer system for improving service agent interaction between a user and one or more service agents of claim 1, wherein the at least one service agent includes a business workflow service that executes one or more business workflows, wherein a business workflow is a logical progression of steps to achieve a business end.

9. The computer system for improving service agent interaction between a user and one or more service agents of claim 1, wherein the at least one service agent includes a natural language processing (NLP) preprocessing service comprises an agent that performs NLP operations based on user input, where the operations are elected from a group consisting of tokenization, lemmatization, spell correction, and part of speech (POS) tagging.

10. The computer system for improving service agent interaction between a user and one or more service agents of claim 1, wherein the at least one service agent includes a sentiment analysis service comprising a first agent that analyzes and stores an analysis of user sentiment in a user profile in working memory and a second agent that determines a bot sentiment that sets a tone of response being delivered to the user.

11. A method for improving service agent interaction between a user and one or more service agents comprising:
receiving an input query from a user;
forwarding the input query to a contract net initiator (CNI), wherein a CNI initiates a bid for a response to the input query; and
forwarding the bid to at least two contract net responder (CNR) agents in communication with the CNI, wherein the at least two CNRs forward the bid to CNIs that negotiate with one or more service agents that provide possible responses to the user query;
wherein when at least one service agent provides a response to the query, a CNI associated with the one or more service agents that provide a possible response to the query forwards the possible response to a CNR in communication therewith, wherein the CNI that initiated the bid for a response to the input query evaluates the possible responses and forwards the responses to the user as a result of the evaluation.

12. The method for improving service agent interaction between a user and one or more service agents of claim 11, wherein the CNIs and CNRs form a network logic wherein CNIS are in communication with either CNRs or service agents and CNRs are only in communication with CNIs.

13. The method for improving service agent interaction between a user and one or more service agents of claim 11, wherein each of the at least one service agents provides a different expertise that may be responsive to the user input query.

14. The method for improving service agent interaction between a user and one or more service agents of claim 11, further comprising universal service agents that are responsive to all of the at least one service agents through a CNI agent and provide information to all of the at least one service agents, which information may assist in the service agents preparing a possible response.

15. The method for improving service agent interaction between a user and one or more service agents of claim 11, wherein the at least one service agent includes a working memory service comprising subagents embodied in machine readable memory, wherein agent one remembers the current instance of the user interaction with the system, agent two remembers current user intent, and agent three fills a user profile and remembers the user profile for later retrieval.

16. The method for improving service agent interaction between a user and one or more service agents of claim 11, wherein the at least one service agent includes a user intent identification service comprising a first agent that derives user intent and a second agent that derives user intent by asking probing questions of a user.

17. The method for improving service agent interaction between a user and one or more service agents of claim 11, wherein the at least one service agent includes an instance identification service comprising a first agent that recommends features to a user based on a user profile and a second agent that selects an instance from a user query and stores the instance to working memory.

18. The method for improving service agent interaction between a user and one or more service agents of claim 11, wherein the at least one service agent includes a business workflow service that executes one or more business workflows, wherein a business workflow is a logical progression of steps to achieve a business end.

19. The method for improving service agent interaction between a user and one or more service agents of claim 11, wherein the at least one service agent includes a natural language processing (NLP) preprocessing service comprises an agent that performs NLP operations based on user input, where the operations are elected from a group consisting of tokenization, lemmatization, spell correction, and part of speech (POS) tagging.

20. The method for improving service agent interaction between a user and one or more service agents of claim 11, wherein the at least one service agent includes a sentiment analysis service comprising a first agent that analyzes and stores an analysis of user sentiment in a user profile in working memory and a second agent that determines a bot sentiment that sets a tone of response being delivered to the user.
